(19) United States
(12) Patent Application Publication
(10) Pub. No.: US 2010/0194349 A1
(43) Pub. Date: Aug. 5, 2010

(54) ROUTER DEVICE

(75) Inventors: Akihito HIBI, Nagoya-shi (JP); Yoshiteru TAMURA, Nagoya-shi (JP)

Correspondence Address: Beyer Law Group LLP, P.O. BOX 1687, Cupertino, CA, 95015-1687, US

(73) Assignee: Buffalo Inc., Nagoya-shi (JP)

(21) Appl. No.: 12/692,501

(22) Filed: Jan. 22, 2010

(30) Foreign Application Priority Data
Jan. 30, 2009 (JP) 2009-20291

(51) Int. Cl. H02J 7/00; G06F 3/048

(52) U.S. Cl. 320/136; 715/808

(57) ABSTRACT

The router device acquires detected temperature T from a thermistor provided inside the battery box containing secondary battery that provide the power supply, and if the detected temperature T is not smaller than a threshold value Th1, produces flashing display of an LED to alert the user. If the detected temperature T is not smaller than a threshold value Th2 additionally, supply of power to the CPU of the router device is subsequently interrupted. In this way, in a router device powered by a secondary battery, diminished functionality of the secondary battery due to elevated temperature may be prevented.

### CROSS-REFERENCE TO RELATED APPLICATION

The present application claims priority from Japanese application P2009-20291A filed on Jan. 30, 2009, the content of which is hereby incorporated by reference into this application.

### BACKGROUND

1. Field of the Invention

The present invention relates to a router device adapted to forward communication packets over a network.

2. Description of the Related Art

Recent advances in networking technology have led to widespread adoption of mobile computing. In the field of router devices as well, compact products that are ultraportable have been developed. Devices designed to utilize secondary battery or the like as the power supply can be contemplated as one type of such router device.

However, if such a router device powered by secondary battery is used in a high temperature environment, or if the temperature in proximity to the secondary battery should become elevated due for example to latch-up of a component situated in proximity to the secondary battery, the secondary battery may experience degraded performance or failure.

### SUMMARY

With the foregoing in view, it is an object of the present invention to provide a router device powered by secondary battery, wherein diminished functionality of the secondary battery due to elevated temperature may be prevented.

The above objects of the present invention may be attained at least in part according to the following aspects and embodiments of the invention.

One aspect of the invention thereof resides in a router device comprising:

a battery connection portion adapted to connect to secondary battery and to receive supply of power from the connected secondary battery to the router device;

a power control portion adapted to control conditions of supply to the router device of power that has been received from the secondary battery; and

a temperature detection portion adapted to detect temperature in the vicinity of the secondary battery;

wherein the power control portion interrupts supply of power to the router device when the detected temperature is not smaller than a first threshold value.

With the router device of the above design, because the power control portion subsequently interrupts supply of power to the router device if temperature in the vicinity of the secondary battery reaches a high temperature not smaller than a first threshold value, impaired functionality such as degraded performance or malfunction caused by excessively high temperature of the secondary battery can be avoided.

In another possible arrangement, the router device further includes an alert portion adapted to alert the user of the router device when the detected temperature is not smaller than a second threshold value, prior to interruption of supply of power by the power control portion. With the router device of this design, prior to interruption of supply of power the user will be alerted that the temperature in the vicinity of the secondary battery is not smaller than a second threshold value, so the user can opt to manually turn off the power to the router device and avoid impaired functionality of the secondary battery. Moreover, because the supply of power to the router device is not interrupted without warning, the user will be able to power down the router device at safe timing unlikely to cause any problems in the router device, after having first completed desired operation of the router device.

Here, as one process for providing the aforementioned alert, the alert portion may emit light from a light-emitting device furnished to the alert portion. Because the router device of this design issues alerts through light emission by a light-emitting device, the user can readily ascertain if the temperature in the vicinity of the secondary battery has reached high temperature.

Alternatively an arrangement whereby, as another process for providing the aforementioned alert, the alert portion sends an e-mail alert to a destination which is a preregistered e-mail address may be employed. Because the router device of this design issues alerts through e-mail, the user can readily ascertain if the temperature in the vicinity of the secondary battery has reached high temperature.

Further, as yet another process for providing the aforementioned alert, the alert portion may produce a pop-up display on the display screen of a prescribed information processing device connected to a local area network. Because the router device of this design issues alerts through a pop-up display, the user can readily ascertain if the temperature in the vicinity of the secondary battery has reached high temperature.

In another possible arrangement, these router devices may be additionally furnished with a voltage detecting portion adapted to detect output voltage of the secondary battery, and a correction portion adapted to correct detection characteristics of the voltage detecting portion, using temperature detected by the temperature detection portion. Because router devices of this design use temperature detected by the temperature detection portion for carrying out correction of detection characteristics of the voltage detecting portion as well, temperature correction of voltage detection can be accomplished through a simple arrangement. Conversely, the arrangement can be simpler owing to the use of a temperature detection portion which has been provided for the purpose of temperature correction of power detection.

### BRIEF DESCRIPTION OF THE DRAWINGS

FIG. 1 is an illustration showing a simplified configuration of a router device 20;

FIG. 2 is an illustration showing a specific example of a relationship of discharge capacity and battery voltage of a secondary battery serving as a power supply for the router device;

FIG. 3 is a flowchart depicting the flow of a first operation restriction process in the router device; and

FIG. 4 is a flowchart depicting the flow of a second operation restriction process in the router device.

### DESCRIPTION OF THE PREFERRED EMBODIMENTS

### A. Embodiment

The embodiment of the present invention will be discussed below.

A-1. Device Configuration:

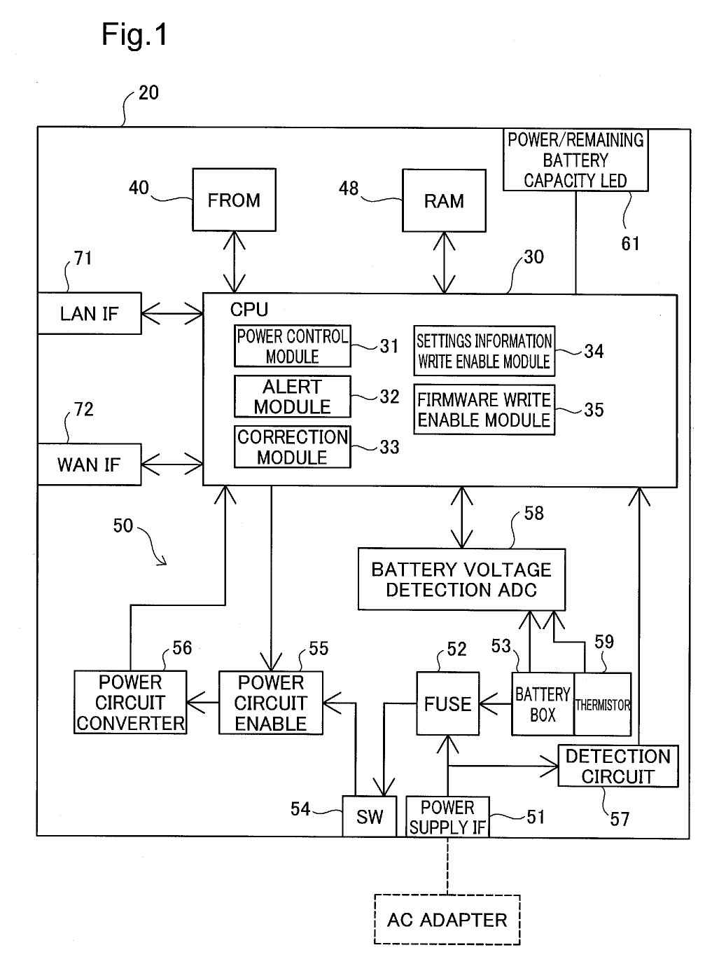

FIG. 1 depicts a simplified configuration of a router device 20 presented as an embodiment of the present invention. The router device 20 is one adapted to forward communication packets from a first network to a second different network. The router device 20 is furnished with a CPU 30, a flash ROM 40, RAM 48, a power control circuit 50, a Power/Remaining Battery Capacity LED 61, a LAN interface 71, and a WAN interface 72, these components being respectively connected by an internal bus.

The CPU 30 controls overall operation of the router device 20 by loading firmware or a program stored in the flash ROM 40 (a rewriteable nonvolatile storage medium) into the RAM 48 and executing the code. The CPU 30 also functions as a power control module 31, an alert module 32, a correction module 33, a settings information write enable module 34, and a firmware write enable module 35. These functions will be discussed in detail later.

The flash ROM 40 is a rewriteable, non-volatile storage medium in which have been saved a boot loader 41, first firmware 43, and second firmware 44. The boot loader 41 is a program that is read and executed first when the router device 20 is powered on, and loads either the first firmware 43 or the second firmware 44. The first firmware 43 is a program used under normal circumstances for control of the various hardware devices of the router device 20. The second firmware 44 is a backup program intended for use in place of the first firmware 43 when the first firmware 43 cannot function properly. The second firmware 44 is a minimal program making it possible to overwrite the first firmware 43, and as such is not intended to carry out the whole range of the operations of the router device 20, such as communication packet forwarding operations.

The power control circuit 50 is a circuit for controlling supply of power to the router device 20, and includes a power supply interface 51, a fuse 52, a battery box 53, a switch 54, an enable circuit 55, a converter circuit 56, a power detection circuit 57, and an analog-digital conversion circuit (ADC) 58 for battery voltage detection.

A thermistor 59 for sensing temperature in the vicinity of the secondary battery installed in the battery box 53 is provided in the interior of the battery box 53. In the present embodiment, the thermistor 59 is disposed at a location substantially at the center part of the four installed secondary battery. The temperature detection means is not limited to a thermistor, and other temperature detection means such as a thermocouple may also be used. The thermistor 59 installation location is not limited to the interior of the battery box 53, and may be situated near the battery box 53 instead.

The switch 54 is a slide switch that allows the user to manually switch on and off the power to the router device 20. The enable circuit 55 is a circuit for controlling the conditions under which the CPU 30 is supplied with power from either the power supply interface 51 or the battery box 53 via the fuse 52 and the switch 54; it includes a power supply IC, a latch, and a field effect transistor. Upon receiving a prescribed signal from the CPU 30, the enable circuit 55 will trip the latch, whereupon on the basis of the latch output the power supply IC will place the field effect transistor in the Off state, interrupting the supply of power to the converter circuit 56. The enable circuit 55 additionally includes an input voltage detection circuit. The enable circuit 55 has a circuit design such that a prescribed signal will be output to the latch, interrupting the supply of power in the manner described above, when detected voltage goes below a threshold value. The converter circuit 56 is a DC/DC converter; in the present embodiment, for output to the CPU 30 the input voltage is first converted to 3.3 V, which is the driving voltage of the router device 20.

The power detection circuit 57 is a circuit designed to detect whether power is being supplied via the power supply interface 51, and to output the result to the CPU 30. The battery voltage detection ADC 58 is a circuit for digital conversion of the analog output voltage of the secondary battery installed in the battery box 53, for output to the CPU 30. The battery voltage detection ADC 58 also performs digital conversion of the analog output voltage of the thermistor 59 for output to the CPU 30. The battery voltage detection ADC 58 is designed to receive a signal from the CPU 30, and is capable of switching its output between secondary battery output voltage and secondary battery surrounding temperature. In the present embodiment, the battery voltage detection ADC 58 has 8-bit resolution.

The Power/Remaining Battery Capacity LED 61 is an LED adapted to display the level of output voltage of the secondary battery on the basis of voltage which has been detected by the battery voltage detection ADC 58; in the present embodiment, it is capable of displaying three different colors, namely, green, orange, and red.

The LAN interface 71 is an interface for connection to a local area network (LAN); in the present embodiment, it is a wireless LAN port compliant with IEEE 802.11b/g networking standards. The WAN interface 72 is an interface for connection to a wide area network (WAN); in the present embodiment, it is a slot for a PHS network card.

A-2. Secondary Cell Characteristics

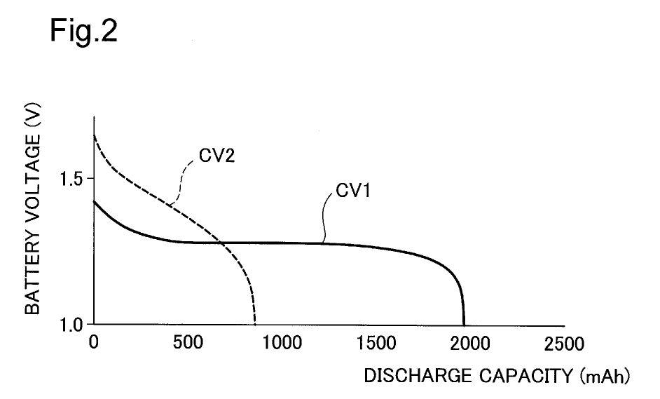

The characteristics of the secondary battery employed as a power supply for the router device 20 in the present embodiment will be discussed with reference to FIG. 2. FIG. 2 is an illustration showing a specific example of relationships between discharge capacity and battery voltage for a secondary battery (rated 1.2 V) and for a manganese dry cell (rated 1.5 V). The characteristics shown were obtained with continuous discharge of 500 mA at 25° C. As shown by the plot CV2, with regard to battery voltage of the manganese dry cell, beginning immediately after initiating service battery voltage declines at a generally constant slope in association with increasing discharge capacity, falling to 1.0 V before discharge capacity reaches 1000 mAh.

On the other hand, as shown by the plot CV1, while a drop in battery voltage of the secondary battery is observed immediately after being placed in service, after dropping to approximately the rated voltage (1.2 V), despite increasing discharge capacity the voltage remains substantially at rated voltage level as discharge proceeds, and at the point in time that discharge capacity reaches around 2000 mAh, drops precipitously to 1.0 V. In this way, as compared to a primary battery, a secondary battery exhibits a greater rate of drop in output starting from the time that a prescribed level of battery voltage has been consumed.

A-3. First Operation Restriction Process (Restriction Based on Sensed Temperature):

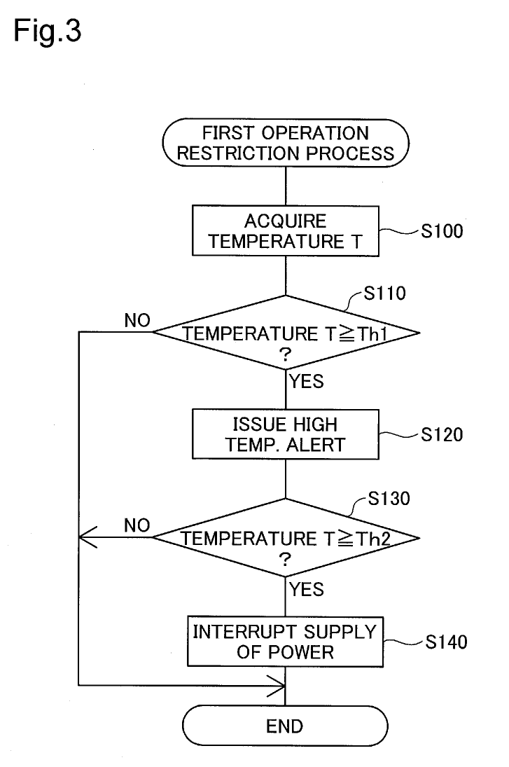

The first operation restriction process of the router device 20 will be described with reference to FIG. 3. Here, the first operation restriction process is one designed to restrict usage of the secondary battery which serve as the power supply for the router device 20, doing so according to the surrounding temperature of the secondary battery. This process is executed in parallel with the packet forwarding process, which is a normal operation of the router device 20; in the present embodiment, the process is executed at prescribed time intervals, switching back and forth between a second operation restriction process to be discussed later. In the present embodiment, the first operation restriction process is executed regardless of whether secondary battery have been installed in the battery box 53.

When the user connects the AC-DC adapter to the power supply interface 51 or installs secondary battery in the battery box 53 and turns the switch 54 to the ON position, the CPU 30 initiates a prescribed initialization process, and the first operation restriction process will be initiated upon completion of this initialization process. When the first operation restriction process is initiated, the CPU 30 will first acquire via the battery voltage detection ADC 58 the detected temperature T from the thermistor 59 (Step S100).

The detected temperature T which is acquired in this instance will also be used for temperature correction of the output characteristics of the battery voltage detection ADC 58. As a specific example, output characteristics for each of a number of temperatures are stored beforehand in a storage medium which has been provided to the battery voltage detection ADC 58; and by way of a process of the correction module 33, the CPU 30 outputs detected temperature T to the battery voltage detection ADC 58, whereby the battery voltage detection ADC 58 will correct offset and gain according to the temperature in question.

Once detected temperature T has been acquired, the CPU 30 will decide whether the detected temperature T is equal to or greater than a first threshold value Th1 (Step S110). In the present embodiment, the threshold value Th1 has been set to 50° C. As a result, if the detected temperature T is less than the threshold value Th1 (Step S110: NO), because the secondary battery service temperature poses no problem, the CPU 30 will terminate the process. On the other hand, if the detected temperature T is equal to or greater than the threshold value Th1 (Step S110: YES), because the surrounding temperature of the secondary battery is approaching excessively high temperature, by way of a process of the alert module 32 the CPU 30 will alert the user of the high-temperature condition (Step S120). In the present embodiment, the CPU 30 issues an alert by producing a blinking display on the Power/Remaining Battery Capacity LED 61.

When the use notices the alert, the user may either manually turn the switch 54 to Off immediately, or manually turn the switch 54 to Off after completing an operation currently being performed, for example, a write operation of firmware or settings information that is stored in the flash ROM 40.

Then, when the user has been alerted, the CPU 30 will decide whether the detected temperature T is equal to or less than a threshold value Th2 (threshold value Th1<threshold value Th2) (Step S130). In the present embodiment, the threshold value Th2 has been set to 70° C. As a result, if the detected temperature T is less than the threshold value Th2 (Step S130: NO), while the secondary battery service temperature is approaching high temperature the level is not such that secondary battery functionality will be markedly diminished, so the CPU 30 will terminate the process. If on the other hand the detected temperature T is equal to or greater than the threshold value Th2 (Step S130: YES), because there is a risk of reaching a level at which secondary battery functionality is markedly diminished, by way of a process of the power control module 31, the CPU 30 will send a prescribed signal to the enable circuit 55 and subsequently interrupt the supply of power to the converter circuit 56 (Step S140). Once the supply of power has been interrupted in this way, the operation restriction process will terminate.

Once the supply of power has been interrupted in Step S140 in this way, in the router device 20 the supply of power will not subsequently resume unless the user manually first turns the switch 54 to the Off position and then to the On position. In the present embodiment, the enable circuit 55 has been designed so that upon receiving from the switch 54 a Reset signal input through this on/off procedure, the field effect transistor will be switched On via the latch and the power supply IC so that supply of power can begin.

The arrangement by which the supply of power is restored is not limited to that described in the example above; in another possible arrangement for example, the router device 20 may be provided with a reset button for restoring power, enabling the user to press the button to restore the power. That is, an arrangement whereby power can be restored only by a manual procedure by the user is preferred. With such arrangements, because power will not be restored unless the user performs a manual procedure, even if the detected temperature T fluctuates around the threshold value Th2, the power will not switch on and off repeatedly. Another reason is higher reliability, since the router device 20 will not restart contrary to the wishes of the user. Another advantage is increased convenience, because once the user has replaced the secondary battery or connected the AC-DC adapter to the router device 20, the router device 20 can be started up again simply by performing on/off operation of the switch 54.

In the present embodiment, the threshold value Th has been set to 50° C. and the threshold value Th2 to 70° C.; however, these threshold temperatures may be set appropriately in consideration of factors such as the performance of the secondary battery being used.

A-4. Second Operation Restriction Process (Restriction Based on Detected Voltage):

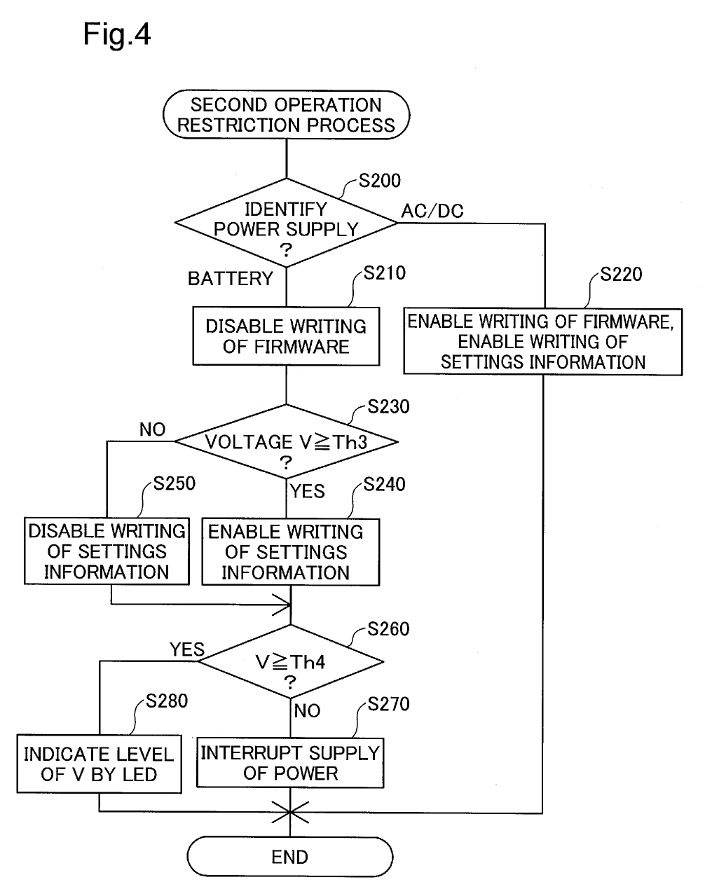

The second operation restriction process of the router device 20 will be described with reference to FIG. 4. This second operation restriction process is one whereby, depending on conditions of power supply to the router device 20, various operations in the router device 20 are restricted. This process is executed in parallel with the packet forwarding process, which is a normal operation of the router device 20, and is executed at prescribed time intervals, switching back and forth between the first operation restriction process discussed above. In the present embodiment, when the user connects the AC-DC adapter to the power supply interface 51 or installs secondary battery in the battery box 53 and turns the switch 54 to the ON position, the CPU 30 initiates a prescribed initialization process, and the second operation restriction process will be initiated upon completion of this initialization process.

When the second operation restriction process is initiated, the CPU 30 will decide upon the type of power supply for the router device 20 (Step S200). The present embodiment is designed such that if the AC-DC adapter has been connected to the power supply interface 51 and at the same time secondary battery have been installed in the battery box 53, preference will be given to the AC-DC adapter power supply; if the power detection circuit 57 has detected supply of power from the AC-DC adapter, it will be decided that the power supply for the router device 20 is the AC-DC adapter, or if supply of power from the AC-DC adapter is not detected, it will be decided that the power supply for the router device 20 is the battery power supply.

As a result, where the power supply for the router device 20 is the AC-DC adapter, by way of a process of the firmware write enable module 35, the CPU 30 will enable firmware write processes and settings information write processes to the flash ROM 40 (Step S220), then terminate the process. Settings information refers to settings information of various kinds relating to router device 20 operation, for example, IP address, SSID, filtering settings, and so on. Entering this enabled state will allow the user to overwrite and update the firmware which is stored in the flash ROM 40, doing so for example using a Web browser from a personal computer that is connected to the router device 20 via the LAN interface 71. It will also be possible for the user to update settings information stored in the flash ROM 40, using a Web browser as described above.

On the other hand, where the power supply for the router device 20 is the secondary battery, by way of a process of the firmware write enable module 35, the CPU 30 will prohibit firmware write processes to the flash ROM 40 (Step S210). The reason for prohibiting the write process during operation on battery power supply is that the firmware write operation is one requiring a relatively extended time period, and if battery voltage should drop during the firmware write operation so that the write operation is interrupted while in progress, there is a risk that the firmware cannot be restored, and that the router device 20 will subsequently become inoperable.

Having prohibited writing of firmware, the CPU 30 will then decide whether the detected voltage V output by the battery voltage detection ADC 58 is equal to or greater than a threshold value Th3 (Step S230).

As a result, if the detected voltage V is equal to or greater than the threshold value Th3 (Step S230: YES), by way of a process of the settings information write enable module 34, the CPU 30 will enable writing of settings information to the flash ROM 40 (Step S240). The reason for enabling writing of settings information as long as voltage at or above a prescribed level is detected, even when the device is running on battery power, is that it is possible for a settings information write operation to be executed within a relatively short time period as compared with writing of firmware, and thus the write operation can be completed before the battery voltage drops to a level at or below the driving voltage of the router device 20.

If on the other hand the detected voltage V is less than the threshold value Th3 (Step S230: NO), by way of a process of the settings information write enable module 34, the CPU 30 will prohibit writing of settings information (Step S250). The reason for prohibiting settings information write processes below a prescribed voltage in this way is that if battery voltage should drop during a settings information write operation causing the write operation to be interrupted while in progress, the settings data may be determined to be improper data, thus requiring measures such as a reset of the settings through initialization.

In the present embodiment, the threshold value Th3 has been set to 4.5 V; the reason for doing so is that when output voltage reaches about 1.12 V (4.48 V for four battery), the secondary battery used in the present embodiment begin to experience a faster rate of drop in output voltage. It will be preferable to set this threshold value appropriately with reference to factors such as the time required to write the settings information, the secondary battery characteristics (e.g. output voltage drop characteristics and voltage fluctuation characteristics), the number of secondary battery being used, and the magnitude of the differential between the threshold value and the driving voltage of the router device 20, to arrive at a value such that the settings information write operation can complete reliably.

Once restriction of writing of settings information has been set up in this way, the CPU 30 will then decide whether the detected voltage V is equal to or greater than a threshold value Th4 (threshold value Th3>threshold value Th4) (Step S260).

As a result, if the detected voltage V is equal to or greater than the threshold value Th4 (Step S260: YES), the CPU 30 will light up the Power/Remaining Battery Capacity LED 61 with a color that corresponds to the detected voltage V (Step S280) in order to indicate the detected voltage V level, and will then terminate the process. In the present embodiment, if detected voltage is 4.8 V or above the Power/Remaining Battery Capacity LED 61 will light up green; if 4.5 V or above but less than 4.8 V it will light up orange; and if 4.2 V or above but less than 4.5 V it will light up red. The method for indicating the detected voltage V level may be established appropriately, for example, by using a two-color or four-color indication scheme; by indicating level through the on/off status of several LEDs; or by displaying the detection value, or estimated battery remaining capacity based on the detection value, on a liquid crystal panel or the like.

On the other hand, if the detected voltage V is less than the threshold value Th4 (Step S260: NO), by way of a process of the power control module 31, the CPU 30 will send a prescribed signal to the enable circuit 55 and subsequently interrupt the supply of power to the converter circuit 56 (Step S270). Once the supply of power has been interrupted in this way, the second operation restriction process will terminate.

In the present embodiment, the threshold value Th4 has been set to 4.2 V; the reason for doing so is that when output voltage reaches about 1.05 V (4.2 V for four battery), the secondary battery in the present embodiment experience a very fast rate of drop in output voltage. As with the threshold value Th3, it will be preferable to set the threshold value Th4 appropriately with reference to various factors, to a value such that the output of the secondary battery will not fall below the driving voltage of the router device 20, even transitorily.

Once the supply of power has been interrupted in Step S270, the supply of power will not subsequently resume unless the user manually first turns the switch 54 to the Off position and then to the On position. This arrangement is comparable to that of the first operation restriction process discussed earlier.

As mentioned previously, if the detected voltage is lower than a threshold value, the enable circuit 55, using hardware, will interrupt the power to the CPU 30. In the present embodiment, this threshold value Th5 has been set to 3.5 V. The threshold value Th5 may be set to a value less than the threshold value Th4 mentioned above and greater than the driving voltage of the router device 20. By adopting such an arrangement, even if conditions such that the CPU 30 cannot control operation of the router device 20 should arise due to an event such as a software crash for example, i.e. even if conditions are such that the supply of power cannot be interrupted in Step S270, the supply of power can be subsequently interrupted in response to a drop in detected voltage V.

A-5. Effect:

In the router device 20 of the above design, when the detected temperature T of the thermistor provided inside the battery box 53 reaches high temperature equal to or greater than the threshold value Th2, the power control module 31 will subsequently interrupt the supply of power to the CPU 30, so that even if the temperature in the vicinity of the secondary battery should rise due for example to the router device 20 being placed in service in a high-temperature environment or to latch-up of a component of the router device 20, impaired functionality such as degraded performance or malfunction due to excessively high temperature of the secondary battery can be avoided. Additionally, by cutting off power to the router device 20, the user can be made aware that the service environment of the router device 20 is at excessively high temperature.

Additionally, because an alert to the effect that detected temperature T is equal to or greater than the threshold value Th1 is issue prior to interrupting the supply of power, the user can opt to turn off the power himself and avoid impaired functionality of the secondary battery. Moreover, because the supply of power to the router device is not interrupted without warning, the user will be able to power down the router device at safe timing unlikely to cause any problems in the router device 20, after having first completed desired operation of the router device 20. For example, power to the router device 20 will not be cut off without warning despite a firmware write operation being in progress.

Also, the router device 20 is adapted to use the battery voltage detection ADC 58 to detect output voltage of the secondary battery installed in the battery box 53, and to light up the Power/Remaining Battery Capacity LED 61 with a color corresponding to the value of the detected voltage V to indicate the level of the detected voltage V, so that the user can ascertain output conditions of the secondary battery and carry out procedures according to remaining capacity of the battery. For example, from the point in the time that user becomes aware that the secondary battery have low remaining capacity, he or she may opt to avoid operations such as writing of settings information, and as a result, avoid situations in which the router device 20 runs out of power while the operation is in progress. Also, when the detected voltage V falls below the threshold value Th4, the router device 20 will send a prescribed signal to the enable circuit 55 and subsequently interrupt the supply of power to the CPU 30, thereby avoiding situations in which an operation such as writing of settings information is initiated under conditions of minimal remaining capacity of the battery so that power to the router device 20 is cut off while the operation is in progress. Moreover, because the supply of power subsequently remains interrupted once the detected voltage V falls below the threshold value Th4, frequent on/off switching of power to the router device will not take place, even in instances where the output voltage of the battery fluctuates around the driving voltage of the router device 20. In this way, the router device 20 addresses the issue of avoiding problems associated with the use of secondary battery.

Additionally, because the router device 20 performs writing of settings information only when the detected voltage V is equal to or greater than the threshold value Th3, that is, because this write operation is prohibited when remaining battery capacity is very low, problems that might arise if power to the router device 20 cuts out during a write operation can be avoided.

Further, because the router device 20 can be supplied with power from an AC-DC adapter via the power supply interface 51, the router device can be operated in a reliable manner even if remaining battery capacity is very low, so provided that a commercial power supply is available at the location, problems arising when power to the router device 20 runs out during operation of the router device 20 can be avoided.

Additionally, because a firmware write operation will take place only when the router device 20 is being supplied with power from the AC-DC adapter, problems arising when power to the router device 20 runs out during a write operation can be avoided, even during a firmware write operation which requires a relatively long period of time to complete.

As shown by the embodiment herein, the working effects of the router device 20 described above will be particularly notable in instances where secondary battery having the characteristic of a fast rate of drop in battery output voltage starting from a point in time of given usage are employed as the power supply for the router device 20.

Also, because the router device 20 is designed so that if the detected voltage V falls below the third threshold value Th3 the supply of power can be subsequently interrupted through hardware means by the enable circuit 55, the supply of power can be reliably interrupted even in the event of a software crash.

### B. Modifications

### B-1: Modification 1

The embodiment set forth above employs an arrangement whereby, in Step S120 of the first operation restriction process, the router device 20 alerts of high temperature in the vicinity of the secondary battery by flashing the Power/Remaining Battery Capacity LED 61; however, no particular limitation is imposed as to the alert method. For example, the router device 20 could be furnished with an LED exclusively for alert use, and issue alerts by some other light emission process, such as illuminating this LED.

Nor is the alert method limited to one of light emission by a light-emitting device, and an audio alert arrangement would be acceptable as well. Alternatively an arrangement whereby the router device 20 sends an e-mail alert to a preregistered e-mail address of the user would be acceptable.

As another alternative, an arrangement whereby, using JavaScript™ or the like, an alert window pop-up display is produced on the display screen of an information processing device that is connected to the local area network via the LAN interface 71. This display may be produced on a pre-designated information processing device, or on all information processing devices that are connected to the local area network.

### B-2: Modification 2

In the embodiment above, the router device 20 has been designed to execute the first operation restriction process regardless of whether secondary battery have been installed in the battery box 53. By so doing, even if secondary battery have not been installed in the battery box 53, it will be possible to avoid situations in which a component of the router device 20 reaches excessively high temperature due to latch-up or the like, resulting in problems such as malfunction or failure. However, an arrangement whereby the first operation restriction process is executed only if secondary battery are installed in the battery box 53 would also be acceptable. Such an arrangement could be accomplished, for example, by having the CPU 30 determine secondary battery installation status based on output from the battery voltage detection ADC 58; or by providing in the interior of the battery box 53 a switch that is designed to depress when secondary battery are installed, with the determination being made from the On/Off signal of this switch.

### B-3: Modification 3

The embodiment set forth above employs an arrangement whereby when the detected temperature T goes above a prescribed temperature, the user is alerted and the supply of power to the router device 20 is interrupted; however, an alert may be issued and power interrupted when the detected temperature T goes below a prescribed temperature as well. By so doing, the router device 20 will be prevented from operating under conditions in which secondary battery output characteristics are degraded and the power supply becomes unstable owing to a low-temperature environment.

While the present invention has been described in terms of preferred embodiments, it is to be understood that the invention is not limited to these embodiments and as a matter of course may otherwise be reduced to practice in various modes. For example, it is possible to combine only certain selected elements from those shown in the above embodiments and modified examples.

What is claimed is:

1. A router device comprising:
a battery connection portion adapted to connect to secondary battery and to receive supply of power from the connected secondary battery to the router device;
a power control portion adapted to control conditions of supply to the router device of power that has been received from the secondary battery; and
a temperature detection portion adapted to detect temperature in the vicinity of the secondary battery;
wherein the power control portion interrupts supply of power to the router device when the detected temperature is not smaller than a first threshold value.

2. The router device according to claim 1 further comprising an alert portion adapted to alert the user of the router device if the detected temperature is not smaller than a second threshold value, prior to interruption of supply of power by the power control portion.

3. The router device according to claim 2, wherein as one process for providing the aforementioned alert the alert portion emits light from a light-emitting device furnished to the alert portion.

4. The router device according to claim 2, wherein as one process for providing the aforementioned alert the alert portion sends an e-mail alert to a destination which is a preregistered e-mail address.

5. The router device according to claim 2, wherein as one process for providing the aforementioned alert the alert portion produces a pop-up display on the display screen of a prescribed information processing device connected to a local area network to which the router device is also connected.

6. The router device according to claim 1 further comprising:
a voltage detecting portion adapted to detect output voltage of the secondary battery; and
a correction portion adapted to correct detection characteristics of the voltage detecting portion, using temperature detected by the temperature detection portion.
